(19) United States
(12) Patent Application Publication
(10) Pub. No.: US 2012/0091952 A1
(43) Pub. Date: Apr. 19, 2012

(54) CONTACTLESS CHARGING SYSTEM

(75) Inventors: Masanori Oshimi, Tokyo (JP); Haruo Hayakawa, Kanagawa (JP)

(73) Assignee: PANASONIC CORPORATION, Osaka (JP)

(21) Appl. No.: 13/379,981

(22) PCT Filed: Feb. 22, 2010
(86) PCT No.: PCT/JP2010/001154

§ 371 Date: Dec. 21, 2011

(30) Foreign Application Priority Data
Jun. 23, 2009 (JP) 2009-148395

(51) Int. Cl. H02J 7/00

(52) U.S. Cl. 320/108

(57) ABSTRACT

Provided is a contactless charging system which can easily position a primary coil in a contactless charging apparatus and a secondary coil in a device to be charged. The contactless charging system (1) includes a contactless charging apparatus (2) which has a primary coil for transmitting electricity, and a device (3) to be charged which has a secondary coil for receiving electricity. The contactless charging apparatus (2) is configured with casing parts (2A and 2B). Regarding the casing (2A), the primary coil is disposed therein, a circular wall (23) is formed around the primary coil, and the device (3) to be charged can be placed thereon. The size of the wall (23) is determined by the length of the device (3) to be charged in the longitudinal direction and the lateral direction within the acceptable range of positioning. The wall (23) regulates the position of the device (3) to be charged so that the primary coil and the secondary coil overlap within the acceptable range of positioning. Thus, the positioning of the primary coil and the secondary coil is easy, with the only handling of placing the device (3) to be charged on the wall (23).

### TECHNICAL FIELD

The present invention relates to a contactless charging system that includes a contactless charging apparatus having a primary coil for transmitting electricity and a device to be charged having a secondary coil for receiving electricity, the contactless charging system electromagnetically coupling the primary and secondary coils to transmit power from the primary coil to the secondary coil.

### BACKGROUND ART

In a contactless charging system, it is important to position a primary coil and a secondary coil within an acceptable range so as to increase transmission efficiency of power. Regarding a method of positioning the primary coil and the secondary coil, Patent Literature 1, for example, discloses a charging system in which a convex part is provided to a charging device (which corresponds to a contactless charging apparatus), and a concave part to be fitted with the convex part is provided to a portable terminal (which corresponds to a device to be charged), thereby positioning the primary coil and the secondary coil by means of a relation of the convex part and the concave part.

Further, in a contactless charging system disclosed in Patent Literature 2, a mirror part is provided to a contactless charging apparatus, and a center position mark is provided to a portable phone (which corresponds to a device to be charged), and the central position mark of the portable phone is projected onto the mirror part of the contactless charging apparatus to position the primary coil and the secondary coil.

### Citation List

### Patent Literature

Patent Literature 1: JP-2008-206234A

Patent Literature 2: JP-2008-301553A

### SUMMARY OF INVENTION

### Technical Problem

However, even in the methods disclosed in Patent Literatures 1 and 2, the positioning is made with groping, so that it is not possible to make a position in a short time. That is, it is not possible to easily position the primary coil in the contactless charging apparatus and the secondary coil in the device to be charged.

The present invention has been made to solve the above problem. An object of the invention is to provide a contactless charging system that can easily position a primary coil in a contactless charging apparatus and a secondary coil in a device to be charged.

### Solution to Problem

A contactless charging system according to an aspect of the invention includes a contactless charging apparatus that has a primary coil for transmitting electricity and a circular wall formed around the primary coil, and a device to be charged that has a secondary coil for receiving electricity arranged at a substantial center thereof. When the device to be charged is placed on the contactless charging apparatus, the wall regulates a position of the device to be charged so that the primary coil and the second coil overlap within an acceptable range of positioning.

According to the above configuration, the circular wall of the contactless charging apparatus regulates the position of the device to be charged so that the primary coil of the contactless charging apparatus and the secondary coil of the device to be charged overlap within the acceptable range by the circular wall so as to keep the predetermined transmission efficiency of power. Accordingly, the positioning of the primary coil and the secondary coil is easy, with the only handling of placing the device to be charged on the wall of the contactless charging apparatus.

According to the above configuration, even when the device to be charged is placed on the wall of the contactless charging apparatus in any direction, the primary coil and the secondary coil can always keep the predetermined transmission efficiency of power. Therefore, it is possible to transmit the power with the constant efficiency.

Also, a contactless charging system according to an aspect of the invention includes a contactless charging apparatus that has a primary coil for transmitting electricity and a circular wall formed around the primary coil, and a device to be charged that has a secondary coil for receiving electricity arranged at a substantial center thereof. Where a length of the device to be charged in a longitudinal direction is X, a length thereof in a lateral direction is Y, and an acceptable range of positioning of the primary coil and the secondary coil is S, a radius r of the wall of the contactless charging apparatus is calculated by an equation of r={(X/2)²+(Y/2+S)²}^{1/2}.

According to the above configuration, it is possible to calculate an optimal radius of the wall that should be provided to the contactless charging apparatus so as to regulate a position of the device to be charged. Also, taking the acceptable range of positioning into a consideration, a device to be charged having another shape can be also applied. That is, when a device to be charged is placed on the wall of the contactless charging apparatus, which satisfies the condition of the radius r, there is a gap having a range that does not lower the efficiency. Therefore, it is possible to place the device to be charged on the circular wall without paying attention to the direction or position thereof.

Also, a contactless charging apparatus according to an aspect of the invention includes a primary coil for transmitting electricity; a circular wall formed around the primary coil; and a leg part. A main body of the contactless charging apparatus is fixed at an inclined angle by the leg part. When a device to be charged is placed on the contactless charging apparatus, the wall engages the device to be charged at least at two corners of the device to be charged.

According to the above configuration, it is possible to charge the device to be charged with the device being propping up. Thereby, when the device to be charged is a portable phone that can receive digital TV broadcasting or the like, it is possible to provide an optimal angle for the watching of the digital TV broadcasting or the like and to charge the portable phone while watching the digital TV broadcasting or the like.

In addition, a device to be charged according to an aspect of the invention includes a battery cover that covers a center position at which a midpoint of a housing in a longitudinal direction and a midpoint thereof in a lateral direction intersect. A secondary coil for receiving electricity is arranged in the battery cover around the center position and the battery cover is fitted to the housing while a step is not generated between a surface of the battery cover and a surface of the housing.

According to the above configuration, when the battery cover is fitted to the housing of the device to be charged, the secondary coil provided in the battery cover is arranged around the center position at which the midpoint of the housing of the device to be charged in the longitudinal direction and the midpoint of the housing in the lateral direction intersect, within the acceptable range of positioning. Accordingly, it is possible to match the secondary coil with the primary coil that is arranged at the substantial center of the wall of the contactless charging apparatus. Also, the battery cover is fitted to the housing of the device to be charged, so that there is no step between the surface of the battery cover and the surface of the housing. Hence, it is possible to place the device to he charged on the wall of the contactless charging apparatus without rattling.

### Advantageous Effects of Invention

According to the aspects of the invention, it is possible to easily position the primary coil in the contactless charging apparatus and the secondary coil in the device to be charged.

### BRIEF DESCRIPTION OF DRAWINGS

FIG. 1 is a perspective view showing an outward appearance of a contactless charging system according to an embodiment of the invention.

FIG. 2 is a front view of the contactless charging system shown in FIG. 1.

FIG. 3 is a side view of a contactless charging apparatus shown in FIG. 2.

FIG. 4 is a perspective view showing an outward appearance of the contactless charging apparatus shown in FIG. 1.

FIG. 5 illustrates a method of calculating a radius of a wall of the contactless charging apparatus shown in FIG. 2.

FIG. 6 illustrates a method of propping the contactless charging apparatus shown in FIG. 2.

FIG. 7 illustrates the method of propping the contactless charging apparatus shown in FIG. 2.

FIG. 8 is a perspective view showing an outward appearance of the contactless charging apparatus shown in FIG. 2 when it is Used with propping up.

FIG. 9 shows that a circular sheet having a picture drawn thereon is arranged on a bottom surface of the wall of the contactless charging apparatus shown in FIG. 2.

FIG. 10 is a perspective view showing an outward appearance of a front side of a portable phone shown in FIG. 1.

FIG. 11 is a side view of the portable phone shown in FIG. 1.

FIG. 12 is a perspective view showing an outward appearance of a back side of the portable phone shown in FIG. 1.

FIG. 13 is a perspective view showing a state in which a battery cover is detached from a housing of the portable phone shown in FIG. 1.

FIG. 14 is a perspective view showing an outward appearance of a back side of the battery cover of the portable phone shown in FIG. 1 and a part of an internal structure of the battery cover.

### MODE FOR CARRYING OUT INVENTION

Hereinafter, embodiments of the invention will be specifically described with reference to the drawings.

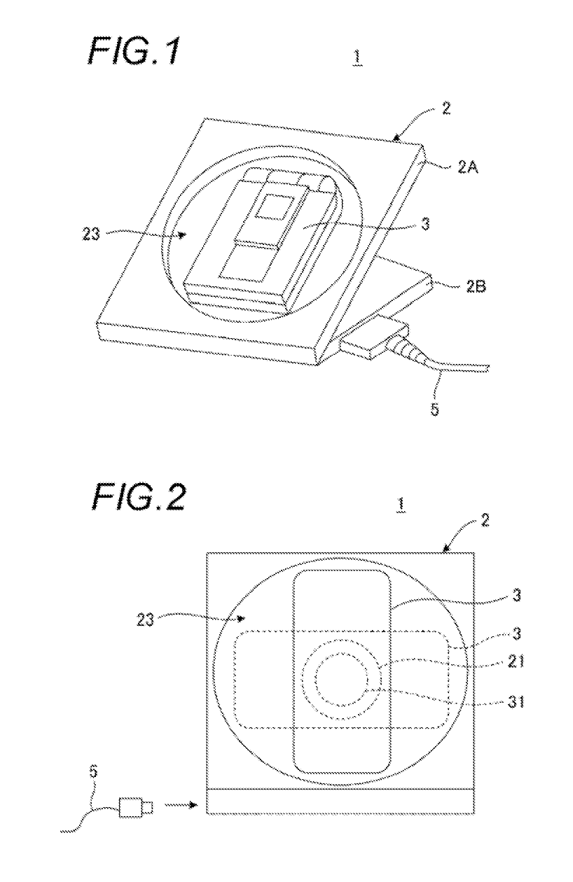

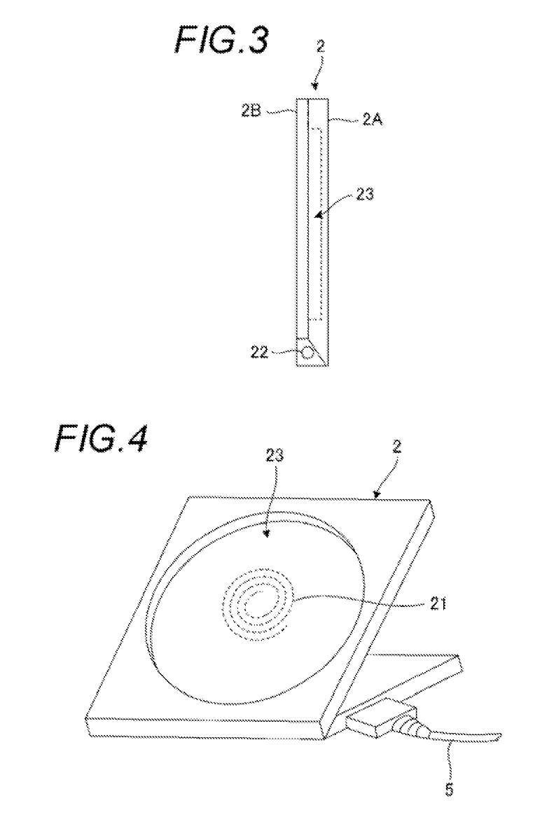

FIG. 1 is a perspective view showing an outward appearance of a contactless charging system according to an embodiment of the invention, FIG. 2 is a front view of the contactless charging system shown in FIG. 1, FIG. 3 is a side view of a contactless charging apparatus shown in FIG. 2, and FIG. 4 is a perspective view showing an outward appearance of the contactless charging apparatus shown in FIG. 1.

In FIGS. 1 to 4, a contactless charging system 1 according to the embodiment includes a contactless charging apparatus 2 that has a primary coil 21 for transmitting electricity and a device 3 to be charged that has a secondary coil 31 for receiving electricity. In this embodiment, the device 3 to be charged corresponds to a portable phone of a folder type, which is hereinafter referred to as portable phone.

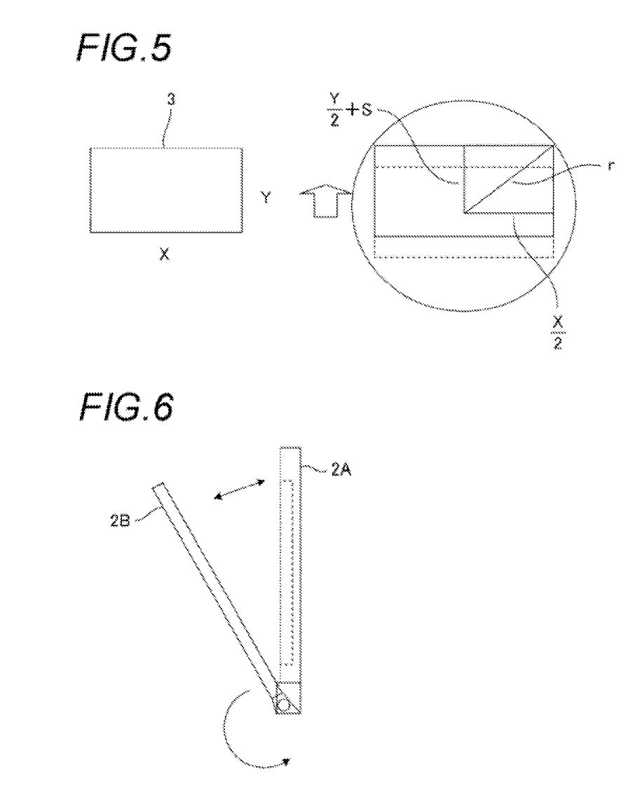

The contactless charging apparatus 2 has casing parts 2A, 2B made of resin materials such as plastic and having a rectangular shape. The casing parts 2A, 2B are connected to each other so that they can be opened and closed around one sides thereof. In this case, a pin 22 (refer to FIG. 3) is used to connect the casing parts 2A, 2B. The casing part 2A is formed with a circular concave portion (hereinafter, referred to as ‘wall’) 23 for placing the portable phone 3 thereon. The primary coil 21 is arranged at a substantial center of the wall 23. Also, a size of the wall 23 is determined by a size of the portable phone 3. As shown in FIG. 5, where a longitudinal size of a surface of the portable phone 3, which is placed on the contactless charging apparatus 2, is X and a lateral size of the surface is Y and an acceptable range of positioning of the primary coil 21 and the secondary coil 31 is S, a radius r of the wall 23 is calculated by a following equation (1).

r={(X/2)²+(Y/2+S)²}^{1/2} (1)

By determining the radius r of the wall 23 as described above, when the portable phone 3 is placed on the wall 23, the primary coil 21 in the contactless chafing apparatus 2 and the secondary coil 31 in the portable phone 3 are positioned without fail within the acceptable range of positioning S. As the primary coil 21 and the secondary coil 31 are positioned as such, it is possible to transmit the power from the contactless charging apparatus 2 to the portable phone 3 with predetermined efficiency.

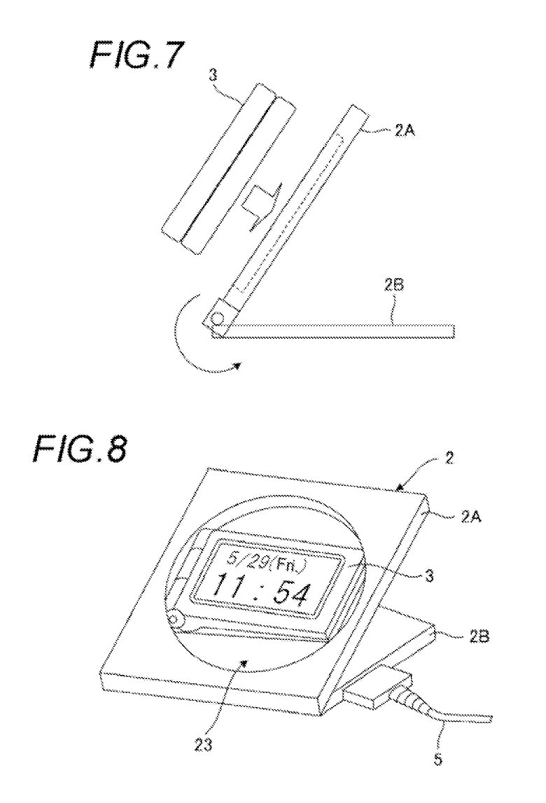

Back referring to FIGS. 1 to 4, the casing part 2B serves as an opening and closing cover with respect to the casing part 2A. Also, as shown in FIGS. 6 and 7, when the casing part 2B is rotated to a predetermined inclined angle, it also functions as a leg part of the casing part 2A. The casing part 2B is enabled to function as the leg part of the casing part 2A, so that a main body of the contactless charging apparatus 2 can be used with propping up. In this case, a fixing mechanism is provided to the casing parts 2A, 2B so that the main body of the contactless charging apparatus 2 is fixed at an inclined angle.

The casing part 2B is provided therein with a power transmission part (not shown) for supplying power to the primary coil 21 provided to the casing part 2A. The power for operating the power transmission part is supplied from the outside through a power supply cable 5 that can be connected to the casing part 2B.

When the portable phone 3 is placed on the wall 23 of the contactless charging apparatus 2, a central part of the primary coil 21 of the contactless charging apparatus 2 and a central part of the secondary coil 31 of the portable phone 3 are positioned within the acceptable range S of positioning. Accordingly even when the portable phone 3 is arranged in any direction about the secondary coil 31, it is possible to transmit the power to the portable phone 3 with high efficiency. The portable phone 3 shown with a dotted line in FIG. 2 is arranged in the lateral direction with respect to the portable phone 3 shown with the solid line in FIG. 2. FIG. 8 is a perspective view showing a state in which the contactless charging apparatus 2 is used with propping up. When the portable phone 3 is arranged in the lateral direction, the portable phone 3 is engaged at least at two corners of the portable phone 3 by a wall surface of the wall 23.

If the portable phone 3 can receive the digital TV broadcasting, when the portable phone 3 is arranged in the lateral direction on the wall 23 with the main body of the contactless charging apparatus 2 propping up, it is possible to arrange the portable phone at a state in which a person can easily watch the digital TV broadcasting or the like. As a result, it is possible to charge the portable phone while watching the broadcasting.

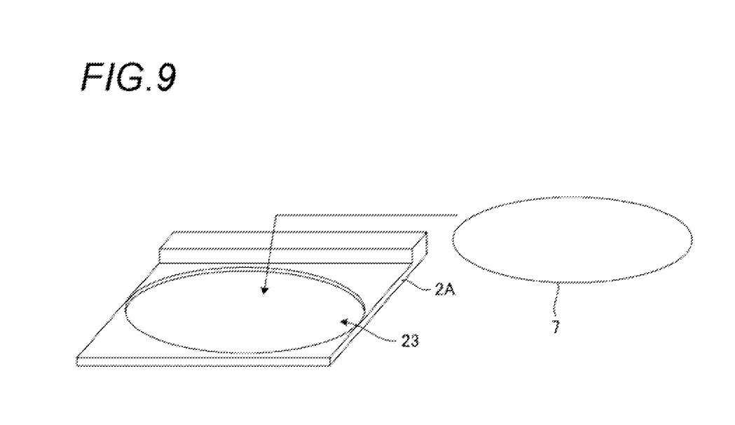

In the meantime, it is possible to draw a picture on a plane of the wall 23 of the casing part 2A. Also, a circular sheet 7 having a picture drawn thereon as shown in FIG. 9 may be placed on the plane of the wall 23 for the purpose of customizing the picture.

In this way, the contactless charging apparatus 2 is configured with the casing parts 2A, 2B made of resin materials such as plastic and having a rectangular shape. The casing parts 2A, 2B are connected to each other so that they can be opened and closed. The casing part 2A is formed with the circular wall 23 for placing the portable phone 3 thereon. The primary coil 21 is arranged at the substantial center of the wall 23. Also, the size of the wall 23 is determined by the length of the surface of the housing of the portable phone 3 in the longitudinal direction and the lateral direction, which the secondary coil of the portable phone 3 is arranged thereon within the acceptable range S of positioning of the primary coil 21 and the secondary coil 31 and which is placed on the contactless charging apparatus 2.

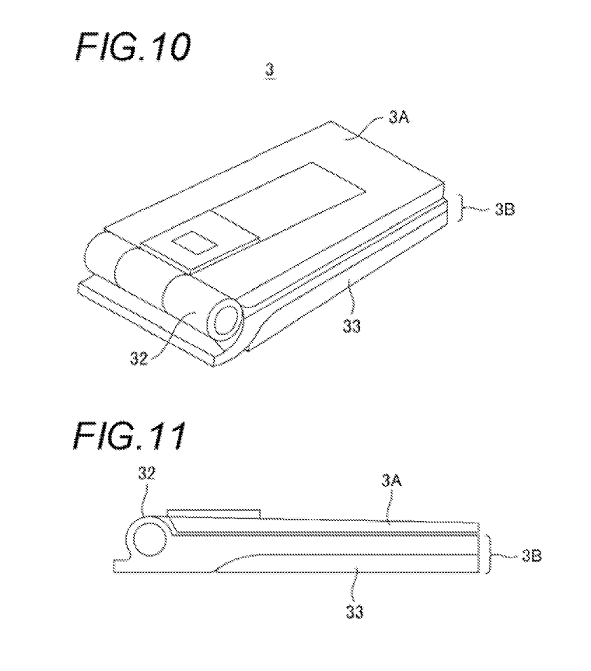

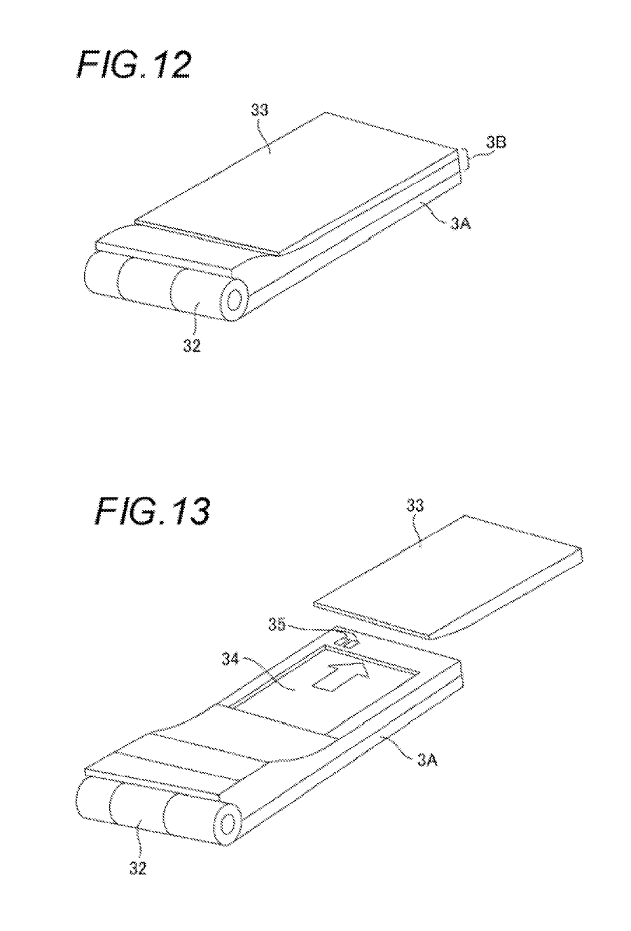

FIG. 10 is a perspective view showing an outward appearance of a front side of the portable phone 3, FIG. 11 is a side view of the portable phone 3, and FIG. 12 is a perspective view showing an outward appearance of a back side of the portable phone 3. In FIGS. 10 to 12, the portable phone 3 has an upper housing 3A and a lower housing 3B. The upper and lower housings are connected by a hinge 32 so that they can be opened and closed. A battery cover 33 is provided at a back side of the lower housing 3B. The battery cover 33 covers a center position at which a midpoint of the surface of the housing of the portable phone 3, which is placed on the contactless charging apparatus 2, in the longitudinal direction and a midpoint of the surface in the lateral direction intersect. Also, the battery cover is fitted to the housing of the portable phone 3 while a step is not generated between the surface of the battery cover 33 and the surface of the housing of the portable phone 3.

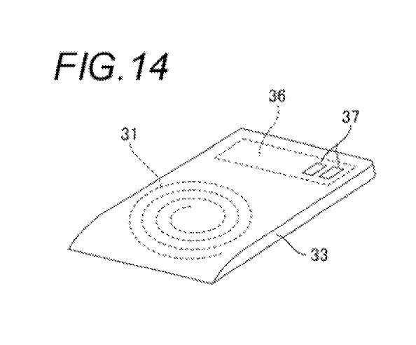

FIG. 13 is a perspective view showing a state in which the battery cover 33 is detached from the housing of the portable phone 3. In FIG. 13, when the battery cover 33 is slid and is thus detached from the portable phone 3, a battery (secondary battery) 34 is exposed from the lower housing 3A and a terminal 35 for electrical connection with the battery cover 33 is also exposed. FIG. 14 is a perspective view showing an outward appearance of a back side of the battery cover 33 of the portable phone 3 and a part of an internal structure of the battery cover 33. In FIG. 14, the secondary coil 31 is arranged in the battery cover 33 about the center position and a circuit board 36 is arranged at a rear side in the battery cover 33. A terminal 37 that is connected to the terminal 35 of the lower housing 3B is arranged on a surface on the circuit board 36.

When the battery cover 33 is fitted to the lower housing 3B, the terminal 37 of the battery cover 33 and the terminal 35 of the lower housing 3B are electrically connected. The power received from the secondary coil 31 of the battery cover 33 is transmitted to the lower housing 3B through the terminal 37 of the battery cover 33 and the terminal 35 of the lower housing 3B. A communication circuit (not shown) for communicating with the contactless charging apparatus 2 is assembled to the circuit board 36 in the battery cover 33. For example, when the battery 34 is fully charged, the communication circuit notifies the contactless charging apparatus 2 of the full charge state.

In this way, the portable phone 3 has the battery cover 33 that covers the center position at which the midpoint of the housing in the longitudinal direction and the midpoint thereof in the lateral direction intersect. The battery cover 33 is provided with the secondary coil 31 that is arranged about the center position. The battery cover 33 is fitted to the housing while a step is not generated between the surface of the battery cover 33 and the surface of the housing. When the battery cover 33 is fitted to the housing of the portable phone 3, the secondary coil 31 provided in the battery cover 33 is arranged at the center position at which the midpoint of the surface in the longitudinal direction and the midpoint of the surface in the lateral direction of the housing of the portable phone 3, which is placed on the contactless charging apparatus 2, intersect. Accordingly, the secondary coil matches with the primary coil 21 that is arranged at the substantial center of the wall 23 of the contactless charging apparatus 2. Also, the battery cover 33 is fitted to the housing of the portable phone 3, so that there is no step between the surface of the battery cover 33 and the surface of the housing. Hence, it is possible to place the portable phone 3 on the wall 23 of the contactless charging apparatus 2 without rattling.

In this way, according to the contactless charging system 1 of this embodiment, the wall 23 of the contactless charging apparatus 2 regulates the position of the portable phone 3 so that the primary coil 21 of the contactless charging apparatus 2 and the secondary coil 31 of the portable phone 3 overlap within the acceptable range S of positioning, Accordingly, the positioning of the primary coil 21 and the secondary coil 31 is easy, with the only handling of placing the portable phone 3 on the wall 23 of the contactless charging apparatus 2. That is, it is possible to position the primary coil 21 and the secondary coil 31 very easily.

Thereby, since the central part of the primary coil 21 and the central part of the secondary coil 31 overlap within the acceptable range S of positioning, it is always possible to transmit the power with the constant efficiency even when the portable phone 3 is arranged on the wall 23 of the contactless charging apparatus 2 in any direction.

Also, taking the acceptable range of positioning into consideration, the wall 23 is formed, so that a portable phone having the other shape can be also applied inasmuch as a radius r′ smaller than the radius r expressed by the above equation is satisfied. In this embodiment, the housing has been described which has a rectangular shaped-surface to be placed on the contactless charging apparatus. Alternatively, regarding a housing having a left-right asymmetrical shape, the secondary coil may be arranged about an intersection point of diagonal lines, rather than about the position at which the midpoint of the housing in the longitudinal direction and the midpoint thereof in the lateral direction.

Also, when the casing part 2B configuring the contactless charging apparatus 2 is rotated to a predetermined inclined angle, it functions as a leg part of the casing part 2A, so that the main body of the contactless charging apparatus 2 can be used with propping up. Accordingly, when the portable phone 3 can receive the digital TV broadcasting, it is possible to charge the portable phone while watching the digital TV broadcasting with a lateral screen.

In this embodiment, the wall 23 is obtained by forming the circular concave part on the plane. Alternatively, the wall may be obtained by forming a circular convex part on the plane. In this case, an intermittent wall may be also possible, rather than the continuous wall. When forming the intermittent wall, it is possible to reduce the manufacturing cost.

In this embodiment, the portable phone has been exemplified as the device 3 to be charged. Alternatively, the invention is not limited to the portable phone. For example, a cordless handset of a wired phone, a PDA (Personal Digital Assistant), a player for music reproduction and the like having a chargeable battery mounted thereon are also possible.

Although the invention has been described with reference to the specific embodiment, it is apparent to one skilled in the art that the embodiment can be variously changed or modified without departing from the spirit and scope of the invention.

This application claims the benefit of Japanese Patent Application No. 2009-148395 filed on Jun. 23, 2009, the disclosure of which is incorporated herein by reference.

### INDUSTRIAL APPLICABILITY

According to the invention, it is possible to easily position the primary coil of the contactless charging apparatus and the secondary coil of the device to be charged. The invention can be applied to a contactless charging system including a contactless charging apparatus that has a primary coil for transmitting electricity and a device to be charged that has a secondary coil for receiving electricity.

### REFERENCE SIGNS LIST

1: contactless charging system

2: contactless charging apparatus

2A, 2B: casing part

3: portable phone (device to be charged)

3A: upper housing

3B: lower housing

5: power supply cable

7: sheet

21: primary coil

22: pin

23: wall

31: secondary coil

32: hinge

33: battery cover

34: battery

35, 37: terminal

36: circuit board

1. A contactless charging system, comprising:
a contactless charging apparatus that has a primary coil for transmitting electricity and a circular wall formed around the primary coil; and
a device to be charged that has a secondary coil for receiving electricity arranged at a substantial center thereof, wherein
when the device to be charged is placed on the contactless charging apparatus, the wall regulates a position of the device to be charged so that the primary coil and the secondary coil overlap within an acceptable range of positioning.

2. The contactless charging system according to claim 1, wherein
when the device to be charged is placed on the contactless charging apparatus, a central part of the primary coil and a central part of the secondary coil overlap within an acceptable range of positioning.

3. The contactless charging system according to claim 1, wherein
a surface of the device to be charged, which is placed on the contactless charging apparatus, has a substantially rectangular shape, and
the secondary coil for receiving electricity is arranged about a center position at which a midpoint of the substantially rectangular shaped-surface in a longitudinal direction and a midpoint thereof in a lateral direction intersect.

4. A contactless charging system, comprising:
a contactless charging apparatus that has a primary coil for transmitting electricity and a circular wall formed around the primary coil; and
a device to be charged that has a secondary coil for receiving electricity arranged at a substantial center thereof, wherein
where a length of the device to be charged in a longitudinal direction is X, a length thereof in a lateral direction is Y, and an acceptable range of positioning of the primary coil and the secondary coil is S, a radius r of the wall of the contactless charging apparatus is calculated by a following equation:
r={(X/2)²+(Y/2+S)²}^{1/2}.

5. A contactless charging apparatus, comprising:
a primary coil for transmitting electricity;
a circular wall formed around the primary coil; and
a leg part, wherein
a main body of the contactless charging apparatus is fixed at an inclined angle by the leg part, and
the wall is configured to engage a device to be charged at least at two corners of the device to be charged when the device to be charged is placed on the contactless charging apparatus.

6. A device to be charged, comprising:
a battery cover that covers a center position at which a midpoint of a housing in a longitudinal direction and a midpoint thereof in a lateral direction intersect, wherein
a secondary coil for receiving electricity is arranged in the battery cover around the center position, and
the battery cover is fitted to the housing while a step is not generated between a surface of the battery cover and a surface of the housing.
